(19) United States
(12) Patent Application Publication
(10) Pub. No.: US 2024/0094846 A1
(43) Pub. Date: Mar. 21, 2024

(54) Sector-Based Programmable Touchpad for Computer Devices

(71) Applicant: Joseph Carlo Pastrana, Sneads Ferry, NC (US)

(72) Inventor: Joseph Carlo Pastrana, Sneads Ferry, NC (US)

(21) Appl. No.: 18/527,330

(22) Filed: Dec. 3, 2023

(51) Int. Cl. G06F 3/041; G06F 3/0354; G06F 3/038

(52) U.S. Cl. CPC G06F 3/04166; G06F 3/03547; G06F 3/038

(57) ABSTRACT

A computerized method to electronically designate sectors within a touchpad's surface area for the purpose of executing software-driven user-programmed commands. To execute a command, the method requires the user to be in contact with a specific sector within the touchpad area and the pressing of a specific programmed key within the computer's keyboard. Once the command is entered by the user, the computer device executes the programmed instructions. For example, a user could program a sector of the touchpad to instruct the computer device to provide the user with user-selected websites in various tabs, organized by topics, while programming another sector to activate various software applications or to operate the functions of an application. To allow the user to identify the designated sectors, markings could be printed and/or stamped on the surface and/or perimeter of the touchpad and/or depicted on a computer screen.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### INCORPORATION BY REFERENCE OF MATERIAL SUBMITTED, COMPACT DISC APPENDIX

Not applicable to this application

### STATEMENT REGARDING PRIOR DISCLOSURES BY THE INVENTOR OR A JOINT INVENTOR

Not applicable to this application

### BACKGROUND OF THE INVENTION

The technical field of the invention relates to the entering of computed-coded commands into computing devices to operate the said computing devices, organize, retrieve, and manage electronic documents and data stored on computer information systems and portable computing devices, such as a laptop, tablet, iPad, cellular telephone, networks, or the like. More particularly, the present invention relates to the field of input devices, specifically, the electronic touchpads integrated into laptop computers and the peripheral touchpads electronically connected and operating as input devices to computing devices.

Currently, the “Control” key located in computer devices' keyboards is programmed to provide computer users with previously programmed commands (e.g., pressing and holding the “Control” key and then pressing the “L” key to lock a computer device). Contrary to the prearranged/initially set “Control” key commands in computer devices, the invention provides users with the capability to create their own computer-programmed commands and execute the said commands via the touchpad without interfering with the “Control” key commands/functions.

These and other input devices are still unable to avoid lost productivity problems, especially when multiple computer users in a business setting are repeating the same computer tasks every day. Accordingly, improving input devices and computer-driven methods to increase the uploading of software applications, data management, and data retrieval for computer users remain highly desirable.

### DESCRIPTION OF PRIOR ART

Not applicable to this application

### BRIEF SUMMARY OF THE INVENTION

The invention consists of a computer-implemented touchpad sector-based computer command entry method based on the Cartesian Coordinate System to electronically designate data input sectors within the surface area of a touchpad for the purpose of executing computer-programmed commands based on the sector of the touchpad utilized by a computer user.

The touchpad is a programmable input device electronically connected to a computing device for the purpose of executing computer-coded commands.

To operate the functions of the method, a software program executes the method's instructions and process the computer-programmed user commands. To enter the computer-programmed user commands, the touchpad is utilized by the user in combination and coordination with the keyboard connected to the user's computing device.

A computer screen is electronically connected to the user-operated computing device to visualize the user information input and the computer information output resulting from the user-entered computer-programmed commands and the computer-coded instructions executed by the method.

### BRIEF DESCRIPTION OF THE SEVERAL VIEWS OF THE DRAWINGS

The following figures are included to illustrate certain aspects of the invention and should not be viewed as exclusive embodiments.

FIG. 1 (Sheet 1 of 4) depicts a Touchpad, an input device utilized by computing devices and keyboards. The touchpad allows users to move a cursor with their finger and can be used in place of an external mouse. The touchpad allows users to scroll, select, click, and navigate with their fingers without ever utilizing a mouse. The Touchpad is also known as Trackpad.

FIG. 2 (Sheet 2 of 4) depicts a Touchpad with 4 sectors designated and programmed to enter computer-programmed commands, organize, retrieve, and manage websites and electronic documents accessed by a user's computing device, wherein the method utilizes the Cartesian Coordinated System as the basis to designate sectors and subsectors within a touchpad surface to perform multiple computer-programmed commands. In this illustration, Sector 4 is further subdivided into 4 Subsectors (Subsectors 4A, 4B, 4C, and 4D). Thus, the method provides the user with the capability to create numerous configurations and combinations to enter multiple computer-programmed commands. Further, a set of computer-programmed commands created by the user represents the user's Command Menu and the said computer-programmed commands are stored in the electronic memory of the user's computing device.

FIG. 3 (Sheet 3 of 4) depicts a Command Menu definition example, where the functions of the computer-programmed commands are listed (see FIG. 2 for Touchpad's Sector/Subsector configuration). For example, if the user first touches and maintains contact with Sector 3 and then proceeds to press the “M” key (while maintaining contact with Sector 3), then a MS Excel application is uploaded by the user's computing device, opening a MS Excel file containing the information of the people comprising of the marketing staff in various MS Excel tabs (Tab 1 through Tab 6). But, if the user first touches and maintains contact with Subsector 4B and then proceeds to press the “B” key (while maintaining contact with Subsector 4B), then the MS Excel application is uploaded by the user's computing device, opening a MS Excel file containing the information and the State location of various projects (Tab 1 through Tab 4).

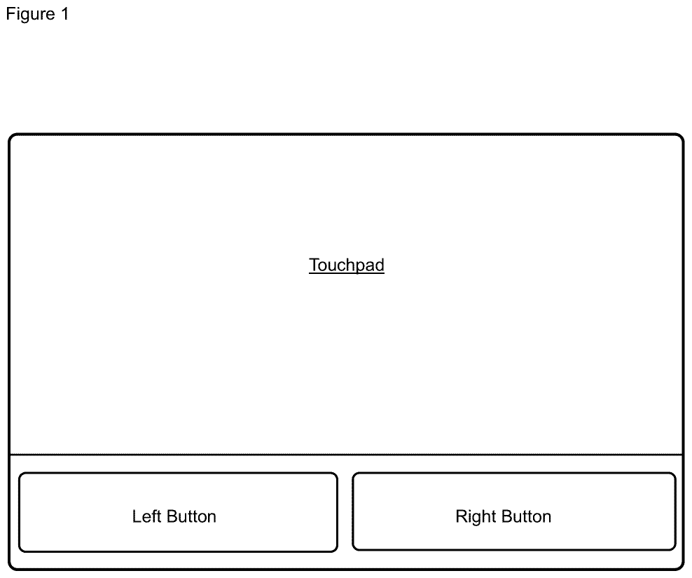

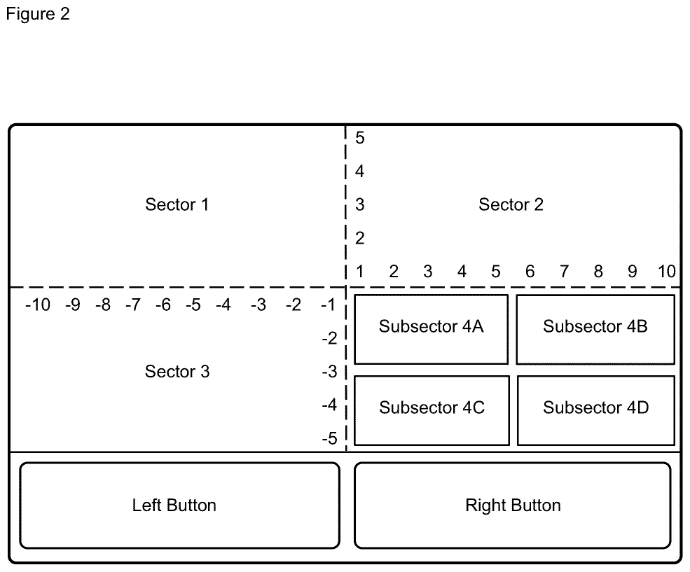

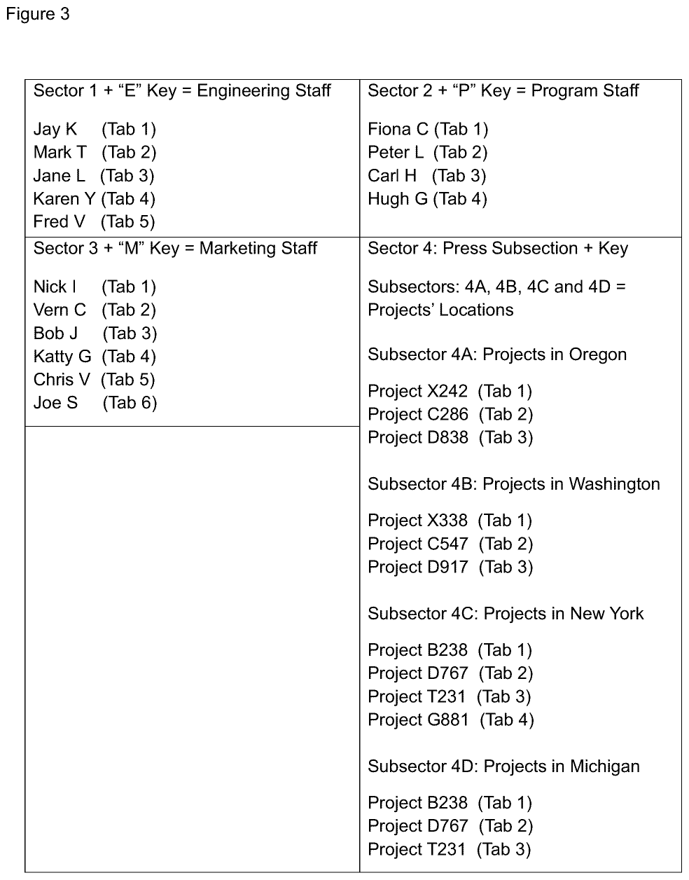

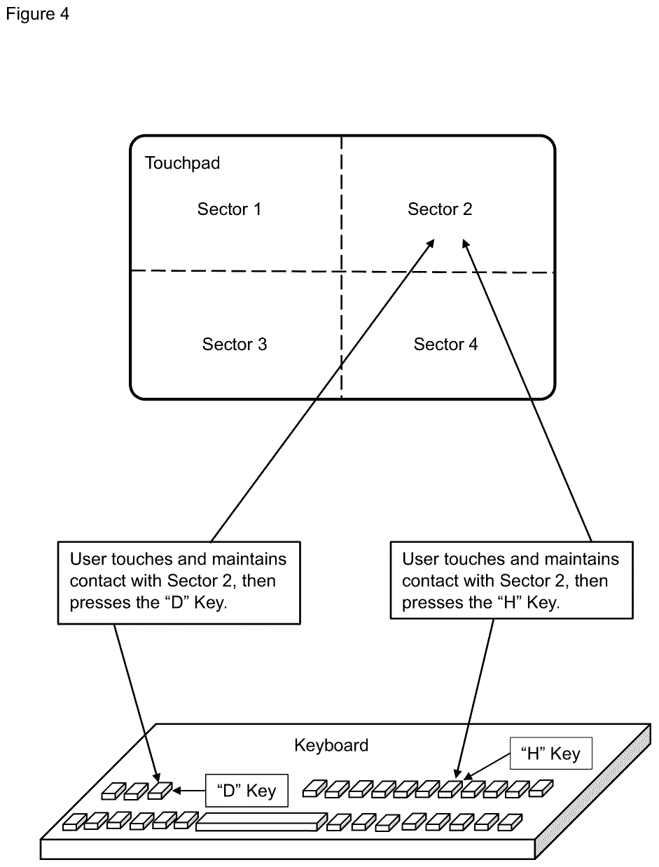

Figure (Sheet 4 of 4) is a pictorial example of a touchpad and a keyboard to illustrate how the method can be utilized, wherein to provide more than four (4) computer-programmed commands to the user, a touchpad with 4 sectors can be programmed by the user to utilize multiple keys within the keyboard to perform hundreds of computer-programmed commands. For example, if the user touches and maintains contact with Sector 2 while simultaneously presses the “D” key located in the keyboard, the computer will perform a specific user-programmed function. Yet, if the user touches and maintains contact with Sector 2 while simultaneously presses the “H” key, the computer will perform a different user-programmed function. Hence, the user can program a touchpad's sector to perform several computer-programmed commands depending on the sector/key combination the user utilizes (the user can utilize several characters, symbols, and numbers from the keyboard in combination with a particular sector to create multiple computer-programmed commands).

### DETAILED DESCRIPTION OF THE INVENTION

The following description of the embodiments of the invention is not intended to limit the invention to these mentioned embodiments, but rather to enable any person skilled in the art to make and use this invention. Thus, the subject matter disclosed is capable of considerable modification, alteration, and equivalents in form and function, as will occur to one having ordinary skill in the art and the benefit of this disclosure and it is to be accorded the widest scope consistent with the principles and features disclosed herein. The term “Computing Device” is used in this patent application to refer to portable computing devices, non-portable computing devices, and computer information systems.

The invention consists of a computer-implemented touchpad sector-based computer command entry method based on the Cartesian Coordinate System to electronically designate command input sectors within the surface area of a touchpad for the purpose of executing computer-programmed commands based on the sector of the touchpad utilized by a computer user. The touchpad is a programmable input device electronically connected to a computing device for the purpose of executing computer-coded commands.

To provide the touchpad with electronically designated sectors, a software program is created and installed into the computing device to electronically subdivide and designate command input sectors within the surface of the touchpad to process the computer user's commands.

A set of computer-programmed commands is created by a user and represents the user's Command Menu, wherein the said set of computer-programmed commands are stored in the electronic memory of the user's computing device.

To operate the functions of the method, the said software program executes the method's instructions and process the computer-programmed user commands. To enter the computer-programmed user commands, the touchpad is utilized by the user in combination and coordination with the keyboard connected to the user's computing device. To perform the entry of a computer-programmed command, the computer user first touches and maintain contact with a specific sector of the touchpad and then enters a specific key from the keyboard programmed to execute a specific computer-programmed command. Numerous computer-programmed commands can be assigned to a specific sector of the touchpad (also known as Trackpad) as multiple combinations of a specific sector and keyboard keys are possible. For example, Sector 2 of a touchpad could be assigned the “A”, “D”, “K”, and “W” keys to perform four (4) different computer-programmed commands, while Sector 3 of the touchpad is assigned the “B”, “C”, “S”, “F”, “H”, and “T” keys to perform an additional six (6) computer-programmed commands.

A computer screen is electronically connected to the user-operated computing device to visualize the user information input and the computer information output resulting from the user-entered computer-programmed commands and the computer-coded instructions executed by the method.

To allow the user to identify the designated sectors, markings are printed and/or stamped on the surface and/or perimeter of the touchpad and/or depicted on a computer screen.

The method is performed by computing devices comprising of processors, database systems, entry devices, displays, wireless transmission systems, electronic connection capabilities to the World Wide Web, and the software developed to process the method operation through users' computing devices, computing devices connected to the websites, and networks connected to the users' computing devices for which the users are entering user-created computer-programmed commands.

The abovementioned description of the embodiments of the invention is not intended to limit the invention. The invention is capable of considerable modification, alteration, and equivalents in form and function and can be utilized in numerous computing devices and computer information systems.

I claim:

1. A computer-implemented method to electronically designate sectors within the surface area of a touchpad for the purpose of executing computer-programmed commands based on the sector of the touchpad utilized by a computer user, wherein the said touchpad is a programmable input device electronically connected to a computing device, the method comprising of: installing, by a computer user, a software program to a computing device, wherein the said software program electronically subdivides and designates computer-programmed command input sectors within the surface of the said touchpad, and execute the computer-coded instructions of the method to process the user's computer-programmed commands; operating, by the said user, the said touchpad in combination and coordination with the said keyboard connected to the computing device to input and execute computer-programmed commands; displaying, on a computer screen electronically connected to the said user-operated computing device, the user information input and the computer information output resulting from the user-entered computer-programmed commands and the computer-coded instructions executed by the said computer-implemented method.

2. The method of claim 1, wherein the said software program electronically subdivides and designates command input sectors within the surface of the said touchpad based on the Cartesian Coordinated System to process the user's computer-programmed commands entered into the user's computing device.

3. The method of claim 1, wherein the said software program electronically subdivides sectors and designates command input subsectors within the surface of the said touchpad based on the Cartesian Coordinated System to process the user's computer-programmed commands entered into the user's computing device.

4. The method of claim 1, wherein the user utilizes the electronically designated sectors and subsectors of the said touchpad in combination with a keyboard connected to the user's computing device to enter in a sequence-based, computer-coded commands into the computing device, wherein every designated sector and subsector of the touchpad is capable to process numerous computer user key entries from the keyboard to execute multiple computer-programmed commands.

5. The method of claim 1, wherein the user assigns specific keys from the keyboard to a specific sector or subsector of the said touchpad to create, program, and execute multiple user-created computer-coded commands.

6. The method of claim 1, wherein the said computing device is comprising of processors, databases, entry devices, displays, wireless transmission capabilities, electronic connection capabilities to networks and the World Wide Web, and the said software program developed to process the operation and function of method.
